(19) United States
(12) Patent Application Publication
(10) Pub. No.: US 2011/0047226 A1
(43) Pub. Date: Feb. 24, 2011

(54) ENHANCED MESSAGING SYSTEM

(75) Inventors: Peter Brian Gabriel, Wiltshire (GB); Andrew Richard Wood, Wiltshire (GB); Michael David Large, Wiltshire (GB)

Correspondence Address: WELLS ST. JOHN P.S., 601 W. FIRST AVENUE, SUITE 1300, SPOKANE, WA, 99201, US

(73) Assignee: Real World Holdings Limited, Wiltshire (GB)

(21) Appl. No.: 12/812,928

(22) PCT Filed: Jan. 14, 2009
(86) PCT No.: PCT/GB2009/000089

§ 371 Date: Nov. 10, 2010

(30) Foreign Application Priority Data
Jan. 14, 2008 (GB) 0800578.7
Mar. 17, 2008 (GB) 0804988.4

(51) Int. Cl. G06F 15/16; G06F 17/30

(52) U.S. Cl. 709/206; 707/758; 707/780; 707/E17.069

(57) ABSTRACT

A system for enabling enhancement of a text-based message with visual assets, the system comprising: input means for receiving message text; a data store comprising a plurality of visual assets; search means arranged to compare data related to the message text received at the input means against data related to the plurality of visual assets stored in the data store in order to identify at least one visual asset that corresponds to a portion of the message text; composing means arranged to receive the at least one visual asset identified by the search means and to compose at least one composed asset set in dependence upon the at least one visual asset identified by the search means and the message text received at the input means; output means arranged to output the at least one composed asset set.

### FIELD OF THE INVENTION

The present invention relates to an enhanced messaging system. In particular, the present invention relates to the field of communication and the exchange of messages between computer systems, mobile communications devices or any combination thereof. The invention may be applied to email messages, instant messaging systems (IM) and messages received at or sent from wireless communications devices such as mobile phones, PDAs and the like.

### BACKGROUND TO THE INVENTION

The role of electronic communications has grown immensely in popularity in recent years and enables people to stay in touch with each other and access large amounts of information from virtually anywhere in the world.

Traditional electronic messaging systems involve the entry of message data, usually in the form of text, followed by the transmission of the message data from a sender to a recipient. The recipient's electronic device is then able to display the message text on a display screen.

This standard form of messaging, or variants thereof, is used in everything from SMS (Short Message Service) messages between mobile phones through to emails and instant messages. Purely text based messaging can however be limited by, for example, the inability to easily convey the emotional context of the message and also by linguistic barriers.

Known enhanced messaging systems include Enhanced Messaging Service (EMS), which is simply an SMS message with additional payload capabilities that allow a mobile phone to send and receive messages that have special text formatting (such as bold or colour), animations, pictures, icons, sound effects, and special ring tones.

A further system is the Multimedia Messaging Service (MMS) which is a standard for telephony messaging systems that allows sending messages that include multimedia objects (images, audio, video, rich text) and not just text as in the Short Message Service (SMS). MMS messages generally comprise a text message that is enhanced by the inclusion of a multimedia asset. For example, simple “slideshow” style presentations can be created that cycle through a number of images and associate text content with each image as it is displayed. The MMS system does not however address the problems identified above with content that is initially entered in text format.

Another form of enhanced messaging is the iconic based communication system by Zlango Ltd that is described in WO2006/075334. The system proposed allows for the entry of a text message which is then transformed into an icon based message for sending. However, the system relies on a straight substitution of predetermined icons for individual words or phrases. Although such a system can go some way to including emotion within a message or making a message more language independent, it is restricted by the fact that a predetermined icon-word association needs to exist before the message can be created.

It is therefore an object of the present invention to provide an enhanced messaging system that overcomes or substantially mitigates the above mentioned problems.

### STATEMENTS OF INVENTION

According to a first aspect of the present invention there is provided a system for enabling enhancement of a text-based message with visual assets, the system comprising: input means for receiving message text; a data store comprising a plurality of visual assets; search means arranged to compare data related to the message text received at the input means against data related to the plurality of visual assets stored in the data store in order to identify at least one visual asset that corresponds to a portion of the message text; composing means arranged to receive the at least one visual asset identified by the search means and to compose at least one composed asset set in dependence upon the at least one visual asset identified by the search means and the message text received at the input means; output means arranged to output the at least one composed asset set.

The present invention provides a system that can enhance a text based message with visual content (visual assets). Visual assets may be still images or animations.

Multiple visual assets may be combined together to form composite assets (e.g. a visual asset that comprises an image of a person with a thought bubble may be combined with a second visual asset comprising a picture of a drink, the combination conveying the message I want a drink).

The system comprises an input for receiving a text based message, a data store for storing visual assets, search means that can search the data store in dependence on the text message received and a composition means for composing visual assets returned by the search means into a composed asset set that is then sent to an output means.

The search means is arranged to compare data related to the message text to data related to the visual assets in order to identify corresponding visual assets.

The present system provides a mechanism for enhancing text based messages in such a way that the above mentioned problems are substantially mitigated. By enhancing a message with visual content the sender is able to convey additional information that is not possible with a purely text based message (e.g. tone, sentiment etc.). It is also noted that by enhancing a message in such a way it is possible to enhance the understanding of the content of the message to users not familiar with the input language.

The present invention therefore provides a system for improving the readability of a text based message.

Conveniently, in order to allow the search means to search the data store each visual asset is associated with one or more pieces of meta-data. The system may also conveniently be arranged to generate meta-data from the input message data and the search means may be arranged to compare the meta-data related to the visual assets in the data store to the meta-data derived from the input text.

The data store may further store substitution patterns that may be used to derive input meta-data from the message text received at the input means.

In order to enable the search means to identify visual assets corresponding to the message text from their corresponding pieces of meta-data, the system may conveniently comprise a relevance indicator which indicates the relevance of the meta data to the associated input text or stored visual asset.

The search means may then be arranged to determine a combined relevance indicator, e.g. by multiplying the relevance indicator relating to the input meta-data with the relevance indicator relating to the asset meta data, which can then be used to determine the most appropriate visual asset that corresponds to the message text.

The search means may be arranged to add visual assets that are identified as corresponding to the input message text to an assets set and preferably the search means may add visual assets in dependence on their determined combined relevance indicator. It is noted that if the combined relevance indicator is used to determine which visual assets to add to the asset set then the search means may be arranged to limit the number of assets added to the set (e.g. the search means may identify the top 5 or top 10 visual assets corresponding to each piece of input meta-data and then add these assets to the asset set. Visual assets outside of the top 5/10 may be discarded).

The composing means may conveniently be arranged to compose any visual asset or assets identified by the search means into a composed asset set. Preferably the search means identifies two or more visual assets and the composing means may then compose these assets into a composed asset set.

Preferably, the composing means may take the asset set identified by the search means and compose the visual assets contained therein into a composed asset set.

It is noted that the composing means may determine all possible combinations of visual assets determined by the search means in order to generate a plurality of composed asset sets. Alternatively, the composing means may be arranged to compose a limited number of composed asset sets.

The composing means may be arranged to determine a composed relevance indicator that indicates the relevance of the visual assets that it has composed/combined together to the message text that was received by the input means. It is noted that the composing means may utilise the input and asset relevance indicators described above to determine a composed relevance indicator for any given composed asset set.

The output means may be arranged to output the at least one composed asset set for display on a display device. This may then allow a user to modify the visual assets that have been selected for enhancing the original message text.

The composed asset set may also be output in the form of an email or instant message communication. It is noted that this form of output may be automatic, i.e. the composing means may be arranged to determine a “best match” of visual assets to the input message text and then output it via the output means. Alternatively, the composed asset set determined by the system may form a “guide” or suggested selection of visual assets that a user may then be able to alter, e.g. by replacing certain visual assets with others available in the data store or by uploading their own visual assets for use.

The output means may be arranged to output a message that comprises visual assets only. Alternatively, the original message text may be output along with the visual assets determined by the system. This latter option provides for a combined message (original text plus visual asset enhancement) thereby ensuring that all the subject matter of the original message is sent along with all the available enhancements.

According to a second aspect of the present invention there is provided a method of enabling enhancement of a text based message with visual assets, the method comprising the steps of: receiving message text; searching a data store comprising a plurality of visual assets and comparing data related to the message text against data related to the plurality of visual assets in order to identify at least one visual asset that corresponds to a portion of the message text; composing at least one composed asset set in dependence upon the at least one visual asset and the message text; outputting the at least one composed asset set.

It will be appreciated that preferred and/or optional features of the first aspect of the invention may be provided in the second aspect of the invention also, either alone or in appropriate combinations.

The present invention extends to an email communication system comprising a system according to the first aspect of the present invention. Conveniently, the email communication system may be arranged to send a weblink to an email that has been enhanced according to the system of the first aspect of the invention.

The present invention also extends to a carrier medium for carrying a computer readable code for controlling a computer or computer server to carry out the method of the second aspect of the present invention.

### BRIEF DESCRIPTION OF DRAWINGS

In order that the invention may be more readily understood, reference will now be made, by way of example, to the accompanying drawings in which:

FIG. 1 is a schematic of a system according to an embodiment of the present invention;

FIG. 2 is a flow chart of the general operation of the system of FIG. 1;

FIGS. 3a and 3b are schematic representations of the use of an embodiment of the present invention in various computer system architectures;

FIG. 4 is an example of meta-data produced in accordance with an embodiment of the present invention from input text;

FIG. 5 is an example of assets and their associated meta-data that may be stored in a system in accordance with an embodiment of the present invention;

FIG. 6 is an example of an asset set that might be output by an embodiment of the present invention;

FIG. 7 is a flow chart depicting the substitution of sub-assets into a main asset;

FIG. 8 is an example of a composed asset set in accordance with an embodiment of the present invention;

FIG. 9 is an example of two assets that may be used in an embodiment of the present invention, along with a representation of the two assets when composed together;

FIG. 10 is an example of a substitution pattern that may be used to generate meta-data from input text in accordance with an embodiment of the present invention;

FIG. 11 is a flow chart depicting the substitution process;

FIG. 12 is a table showing an example of the substitution process of FIG. 11.

### DETAILED DESCRIPTION

It is noted that like numerals are used to denote like features in the Figures and the following description.

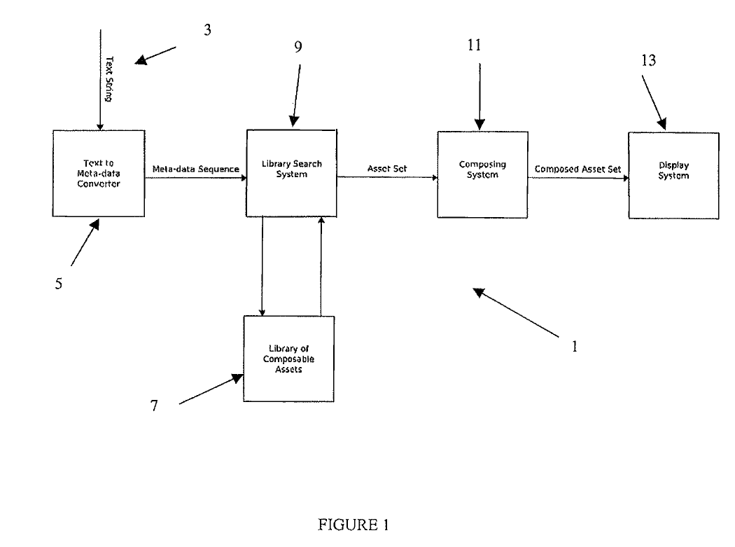

FIG. 1 shows an overview of a messaging system 1 in accordance with an embodiment of the present invention that can be used to take a textually based input message and produce an output message comprising visual content.

The system 1 comprises: input means for receiving an input text string 3; a text to meta-data converter 5 to convert the input text string and convert it into meta-data; a data store 7, or library, of assets that can be composed into a visual output message; a library search system 9 for searching for the library of assets and identifying relevant visual assets based on the input text string; a composer 11 for combining the visual elements identified by the library search system into a message and a display system 13 for displaying the composed message.

Considering the library 7 in greater detail, the assets contained therein may be stored in the form of a database and examples of assets that may be stored within the data store are: bitmap images (e.g. PNG, JPEG type files), vector images (e.g. SVG, Adobe Illustrator format files), video clips (e.g. AVI, MOV, MP4, Flash Video) and animations (e.g. SWF, animated GIF files).

Although the assets are visually based in nature they may additionally comprise other content, e.g. audio content (such as a sound track for a video).

It is noted that some types of asset stored with the library 7 may contain sub-assets (that is, they may be composed in part of other assets). For example, an animation might contain a bitmap image. It is also noted that some types of asset may be decomposable. For example, a vector image in Adobe Illustrator format may be composed of a number layers, with different elements of the image being contained on different layers. As it is possible to separate the image into different assets, one asset corresponding to each layer, for instance, by exporting the image multiple times with only one layer visible at each export, such an asset is decomposable.

It is also noted that some assets may be recomposable, that is they may be built up from a number of other assets. For example, an animation may contain a bitmap image by URL reference, the image being retrieved and displayed only when the animation is displayed. Thus the asset is recomposed each time it is displayed. With some recomposable assets, the asset parts may be interchanged for other assets parts. For instance, when an animation retrieves an image by URL reference, it may be possible for a different image to be retrieved instead, so that the asset may be recomposed out of a variety of sub-assets and a variety of resulting composed assets may be formed.

As explained above, the library 7 comprises a data store of composable assets that may be used in the composition of a visual message. In order to allow the visual assets to be selected each asset is associated with meta-data that describes the visual asset and how it might be composed.

Meta-data for an asset may include meta-data that indicates when that asset might be chosen for some task. For example, the asset meta-data may include a list of text keywords that indicate the asset is appropriate for a task where the keyword is appropriate. Alternatively the asset meta-data may include a category that indicates it is appropriate whenever that category is appropriate.

Other examples of meta-data include pairs of keywords and metrics which indicate a degree to which the asset is appropriate to a task involving the given keyword. For example, meta-data might include keywords and a probability metric, the probability metric indicating the probability that the assets is appropriate when the keyword is appropriate. Such probabilities might be combined using standard rules of probabilities.

For the sake of example, the library 7 might contain the following composable assets:
An animation of a stick-person with a thought bubble, called Asset#1, and with the keyword “think”
   Inside the thought bubble might be a default sub-asset, an image of a question mark, called Asset#2 and with the keyword “a-thought”
An animation of the sun shining, called Asset#3, with the keywords “sun”, “shine”, “sunshine”, “sun shining”
An animation of a person walking a dog, called Asset#4 with the keywords “dog”, “walk”, “walk the dog”

The library of assets is potentially accessible to many users, and many users may potentially contribute assets to the library, or associate meta-data to given assets in the library. For performance reasons, there may in fact be more than one database with some or all of the assets appearing in more than one of the databases. For performance or other reasons, it may be that not all assets are available to all users from all databases. It may in fact be that the library exists only conceptually as a collection of assets that are in fact stored in a highly disparate fashion.

As noted above, the system 1 comprises a text to meta-data converter 5 that is arranged to take the text string as input and provide a set of meta-data, compatible with the type of meta-data in the library 7, to the library search system 9.

For example, the converter 5 may receive the text input “I think the sun is shining” and output keywords, i.e. meta-data, including “think”, “sun”, “shine”, “sun shining”.

In order to convert input text to meta-data, the converter 5 is provided with a set or rules that guide the conversion from text to meta-data. A wide variety of mechanisms for such conversion are possible, e.g. by evaluating the number and frequency of particular words or symbols, recognising character patterns using regular expressions, or by training a neural network to recognise features in the text.

One mechanism for the generation of meta-data would be via the use of substitution rules. The use of substitution rules is described in greater detail later on but it is noted, for example, that each rule might contain an exact input word or sequence of characters, and a corresponding possible substitution as an exact word or sequence of characters. For example, the rule {“thought”:“think”} might indicate that the word “think” can be substituted for the word “thought”. The rule {“sun is shining”:“sunshine”} might indicate that the word “sunshine” can be substituted for the phrase “sun is shining” etc.

Another example rule in the class of rules based on substitutions might include wild-card substitutions. For example, the rule {“think *”: “think a-thought”} might indicate that any sequence of characters following the word think can be substituted with the sequence a-thought, used to indicate that the sequence is a thought.

The system 1 comprises a search system 9 which is used to select assets from the library based on the particular text input via the input means. The search system 9 receives as input the meta-data determined by the text to meta-data converter 5 and uses this to interrogate the library of assets 7 in order to select a set of assets which are then returned as an output to be sent to the composer 11. If, for example, the library assets comprise those described in the above example then the library search system 9 may take the meta-data keyword “sun” and return Asset#3. Alternatively, the keywords “sun”, “dog” may return Assets #3 and #4.

The library search system 9 may be configured to return the asset meta-data only or it may be configured to return the asset and its associated meta-data.

An example of a library search system that could be used in accordance with an embodiment of the present invention is a relational database, for example the MySQL database system, in which tables containing the asset meta-data may be created, and which may then be searched using SQL commands. For example, given a table in a MySQL database called “assets” columns “asset_ID”, “keyword”, “relevance”, the asset-meta-data matching the input meta-data keyword “sun” may be retrieved by the SQL command “SELECT*FROM assets WHERE keyword LIKE ‘sun.

The system 1 also comprises a composer 11 for combining the visual elements identified by the library search system 9 into a message. For example, given one asset that displays a person and a thought bubble, and another asset that consists of a heart, the composing system might create an asset with a heart inside the thought bubble in response to the input text “I think you're lovely”, by composing the heart asset into the thought bubble asset.

The composing system 11 takes as input the meta-data as created by the text-to-meta-data converter 5 and the meta-data of any assets selected by the library search system 9 and outputs a description of one or more composed assets in a format for the display system 13 to understand. For example, the composing system 11 might output SVG (a textual description format using XML specifically designed to describe scalable vector graphics and animations).

The relevance of an asset to the input data and the relevance of assets in the library 7 may conveniently be determined by a relevance score as described in more detail below. Such relevance scores may be used to select the most relevant assets from the library 7 based on the meta-data of the input text and the meta-data associated with the library assets. The relevance scores may also be used by the composer 11 to select the most relevant combination of assets.

Although the composer 11 may be used to automatically select a combination of assets based on the input text it is noted that alternatively a selection of different composed asset outputs may be generated and then output for selection by a user. In a further alternative embodiment, the composer may present the various assets identified in the library search to a user for composition into a visual message.

As noted above the composer may output an asset or a set of composed assets in SVG format for display by the display means. It is noted however that a variety of output formats may be suitable (e.g. Flash, Scalable Vector Graphics (SVG), Synchronised Multimedia Integration Language (SMIL)) and the display means may relate to a stand-alone display system (e.g. on a personal computer) or alternatively may form part of an email system or instant message system.

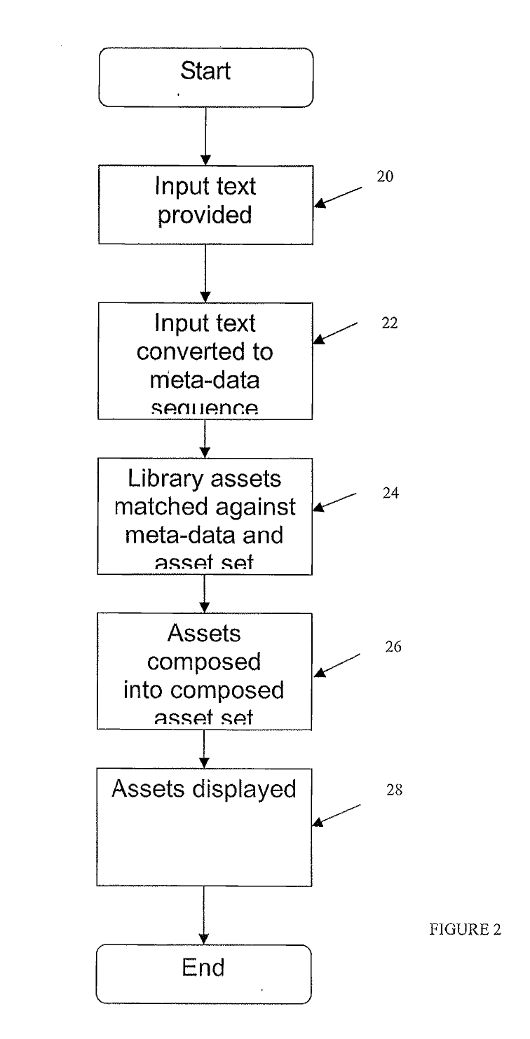

FIG. 2 shows a flow chart depicted how a visual message may be created in accordance with an embodiment of the present invention.

In Step 20, text is input to the system via the input means. Such an input may be a user generated input, for example the input of a text phrase into a form on a web page.

In Step 22, the text to meta-data converter 5 takes the text input and converts it into a collection of meta-data. Whatever the format of the assets and their associated meta-data in the asset library 7 then the converter 5 may be arranged to convert the input text into a compatible format.

In Step 24 the library search system compares the meta-data from the input text to the meta-data of assets in the library of visual assets and outputs a set of matching assets (and optionally their associated meta-data). As described above, the set of matching assets may be determined on the basis of a relevance score associated with different combinations of assets.

In Step 26, the set of matching assets are passed to the composer 11 for composing into a message comprising visual assets. As noted above, the composed message may be determined by the composer 11 on the basis of the relevance score of the composed assets and the most relevant composition chosen by the composer for the output message. In alternative embodiments, a selection of different arrangements of composed assets may be output for further selection by a user of the system 1 or alternatively the set of assets may be presented to the user in such a manner that a manual selection of the composed assets may be made.

In Step 28, the message constructed by the composer 11 is output to a suitable display device 13.

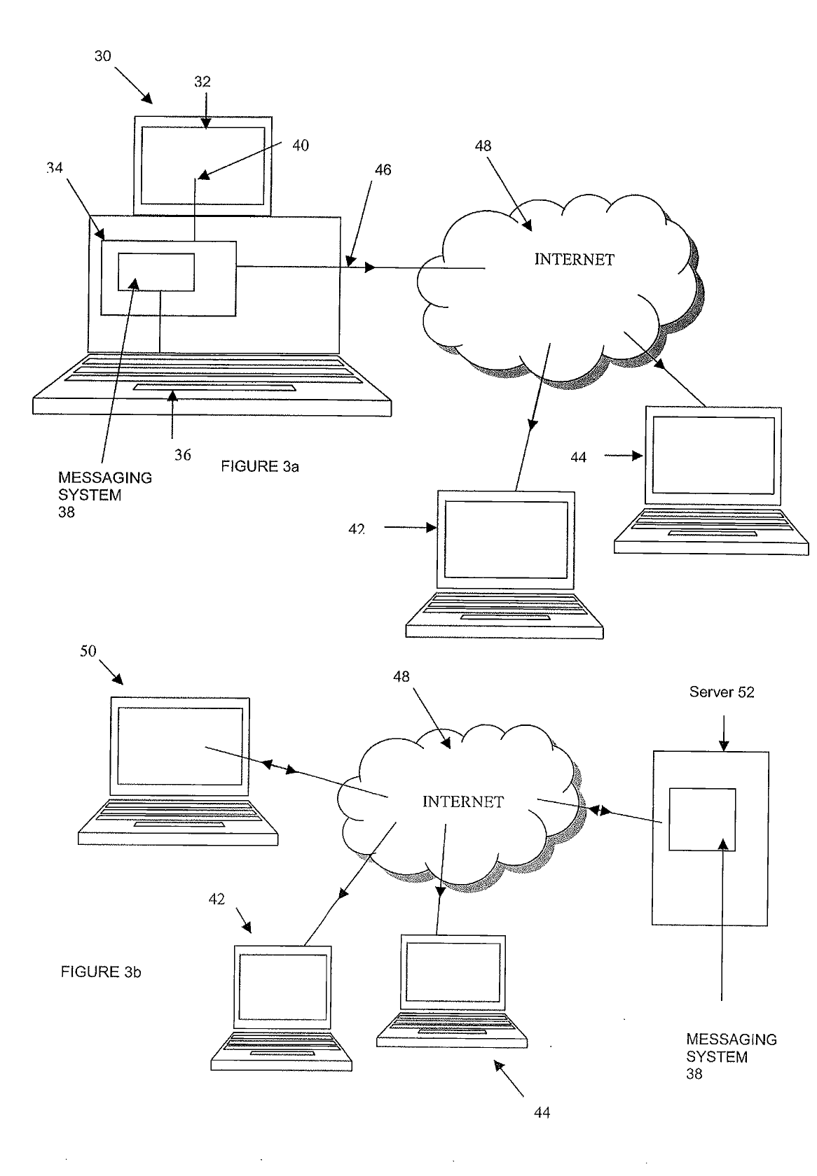

FIGS. 3a and 3b show two different systems which incorporate an embodiment of the present invention.

In FIG. 3a, a user terminal 30 is shown comprising a display means 32, a processor 34 and text input means 36. The processor 34 is configured to run an application 38 that embodies the present invention and it is noted that the application can receive inputs from the text input means 36 and can output a display signal 40 to the display means 32.

The application is also able to communicate with further user terminals 42, 44 via a communication output 46 to the Internet 48 (or other communications network).

In use, a user of the user terminal 30 may enter text to be transformed into an enhanced message comprising one or more visual assets. The application 38 operates on the input text and composes an enhanced message for transmission to one or more of the further user terminals 42,44.

The message sent to the further user terminals 42, 44 may comprise all the text and visual assets required to display the message on the further user terminal. As an alternative however the composed message may be stored on a web server (not shown) and the recipient user on the further user terminal may be provided with a web link which, when selected, displays the composed message.

An alternative system is shown in FIG. 3b. This is a web based composition system in which text entered by the user of user terminal 50 is sent via the Internet to the application 38 which resides in web server 52. In this system, the user of user terminal 50 may compose their message on the web server 52 and once complete the message can either be sent from the web server to one of the further user terminals 42, 44 or a web link to the composed message may be sent.

The overall functionality and architecture of a visual message system in accordance with embodiments of the present invention has been described above. A more detailed example of the operation of such a system is described below.

The following discussion of a system in accordance with an embodiment of the present invention assumes that a meta-data set has already been created by the text to meta-data converter 5 via a suitable process (such as via the use of a substitution pattern). The operation of an example of a text to meta-data converter is however described in detail later in this application.

As noted, the converter 5 transforms an input text string into a sequence of meta-data that the library search system 9 can then use to select appropriate matching assets from the library of assets.

By way of example, the meta-data might consist of a set of string:value pairs, the string being a sequence of characters against which an asset will be matched and the value being a metric used to indicate the quality of a potential match.

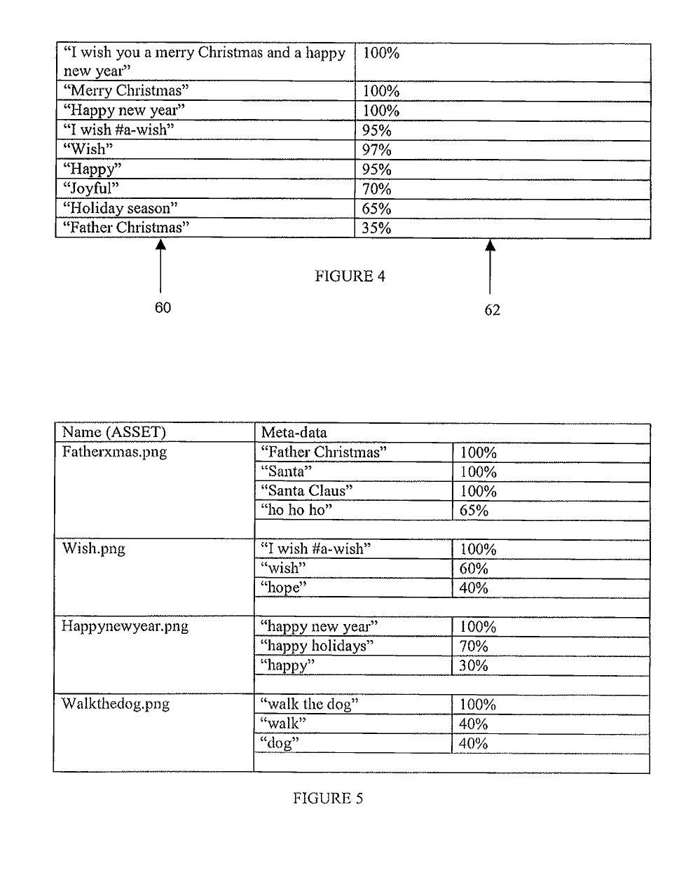

By way of illustration only, an example of meta-data produced from an input text phrase is depicted in FIG. 4. In this example, the input text phrase is “I wish you a merry Christmas and a happy new year”. In FIG. 4, keyword phrases are located in column 60 of the table and their associated meta data in column 62.

As can be seen, in this example the converter 5 has returned nine different keyword phrases each with its own indication of relevance. In this present example therefore, the converter is indicating that an asset with the keyword phrase of “I wish you a Merry Christmas and a happy new year” (i.e. a keyword phrase which is the same as the input text) has a 100% indication of relevance. Similarly, an asset with the keyword phrase “Merry Christmas” also has a 100% indication of relevance. An asset with the keyword phrase of “Father Christmas” is indicated only to have a 35% relevance. The meta-data phrase “I wish #a-wish#” indicates an asset that might be combined with another sub-asset to form a combined asset. The converter indicates that this asset has a 95% indication of relevance.

The library search system 9 is arranged to match library assets 7 against the meta-data of FIG. 4 in order to select a subset of assets in the library 7 that are appropriate to be used by the composer 11. In order for this matching process to occur the assets stored in the library are also associated with their own meta-data.

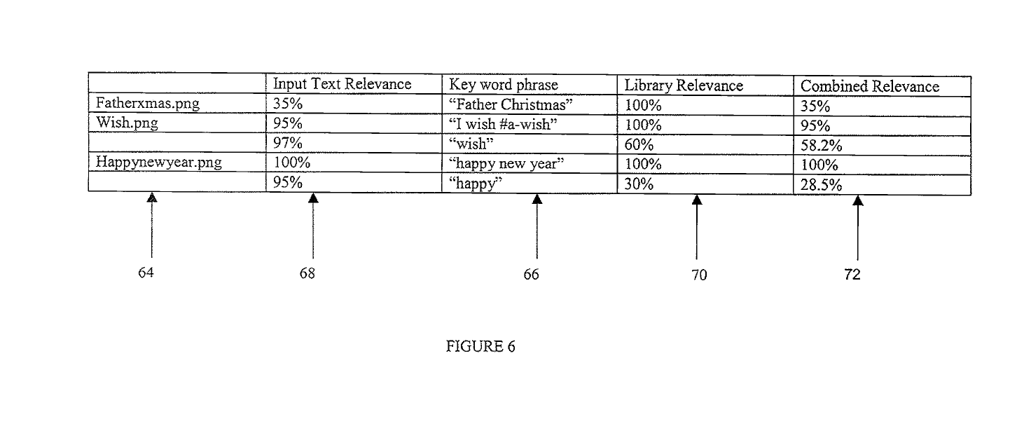

FIG. 5 shows an example of assets that may be stored in the library 7. The associated meta-data for each of the assets is also shown.

It can be seen from FIG. 5 that there are four assets in the library. The assets in this example being the four image files “Fatherxmas.png”, “Wish.png”, “Happynewyear.png” and “walkthedog.png”.

Each asset is associated with meta-data comprising in this example multiple keyword phrases that are associated with the asset along with a relevance indicator.

Taking the “Happy newyear.png” asset, it can be seen that this is associated with three different keyword phrases: (i) “happy new year” which has a relevance indicator of 100%; (ii) “happy holidays” which has a relevance indicator of 70%; and (iii) “happy” which has a relevance indicator of 30%. In other words, “Happynewyear.png” would match an input phrase with a keyword “happy new year” with an indication of relevance of 100%.

Returning to the matching process that occurs in the library search system 9, the meta-data as produced by the text to meta-data converter 5 is matched against the meta-data of assets in the library 7 and an asset set is provided.

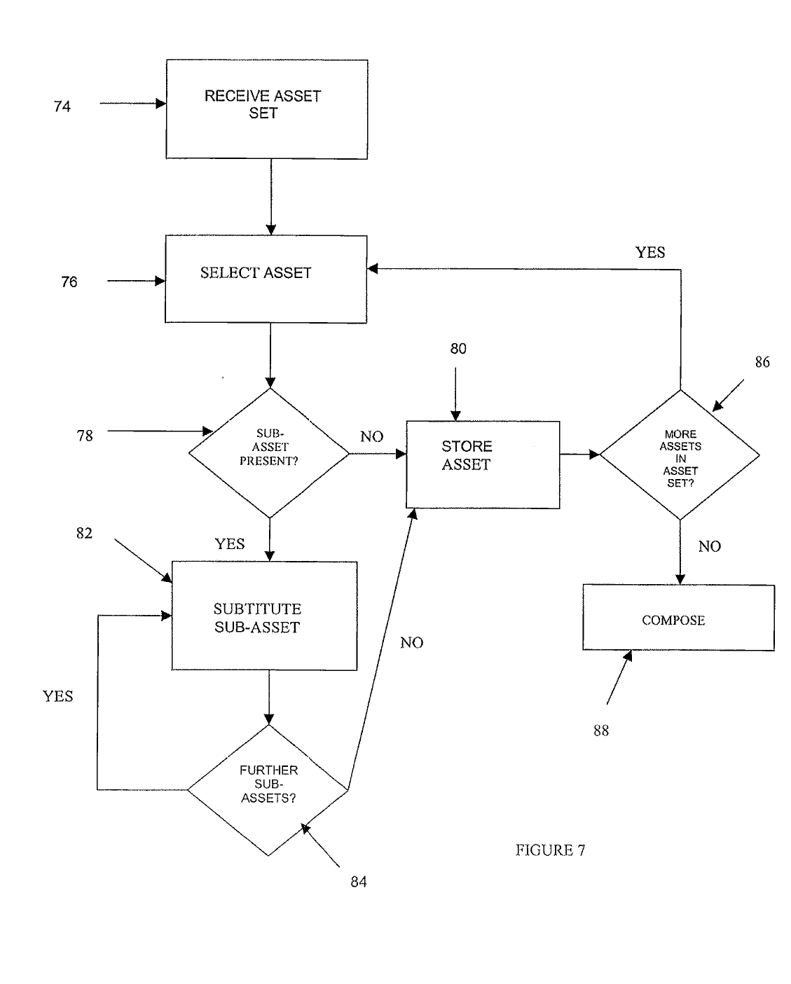

FIG. 6 illustrates one asset set that might be provided by the library search system 9.

In FIG. 6, column 64 indicates which asset is under consideration. It is noted that each of the three assets relates to an image file (“.png” file extension). Column 66 indicates the keyword phrase that is being compared between the input meta-data (column 68) and the library meta-data (column 70).

For each keyword phrase a combined relevance (column 72) may be calculated by taking the product of the input relevance and the matching library asset relevance, i.e.

R_{combined|keyword=X}=R_{input|keyword=X}*R_{asset|keyword=X}

For any given asset, the overall relevance of the library asset to the input text is given by the best combined relevance value, i.e.

$${R}_{combined} = {MAX}_{X} ( {R}_{combined \vert keyword = X} )$$

So, returning to the example of FIG. 6, the relevance for Wish.png may be calculated as follows:
For keyword “I wish #a-wish”, the input relevance is 95% and the library asset relevance is 100%. The combined relevance is therefore 0.95×1.0=0.95 (=95%).
For keyword “wish”, the input relevance is 97% and the library asset relevance is 60%, giving a combined relevance of 0.97×0.60=0.582 (=58.2%).

The overall relevance of the asset to the input text is the best of the possibility values, which in this example is 95%.

Many different asset set representations may be possible for a given input phrase and the system may be tailored to provide greater or fewer number of assets per set as desired.

In the example of FIG. 6, the asset set indicates that three assets have matched the input text (Fatherxams.png, Wish.png and Happnewyear.png). The combined relevance values indicate that Happynewyear.png was matched with a relevance of 100% which suggests that the asset is highly relevant.

Once the library search system 9 has selected a set of assets in response to the input text, the composer 11 is then arranged to produce a set of composed assets based on the input text and the set of assets generated by the library search system.

It is noted that any given asset may have a number of sub-assets. For example, in the case of the thought bubble asset given above it is possible to substitute a sub-asset (representing the subject of the thought bubble) into the main asset.

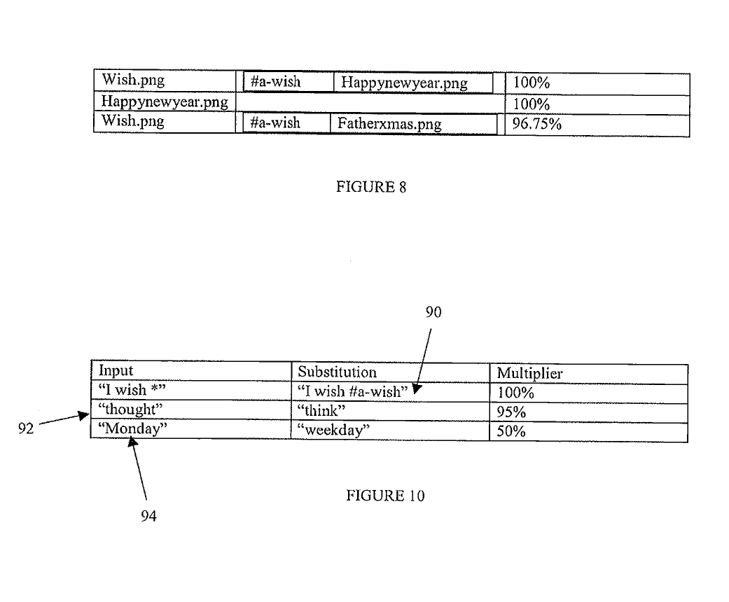

FIG. 7 is therefore a flow chart showing how sub-assets are substituted into an asset ready for composition into a visual message.

In Step 74, the asset set from the library search system 9 is received.

In Step 76 an asset is selected and a check is made in Step 78 whether the selected asset requires a sub asset to be inserted.

If no sub asset is required then the asset is stored, in Step 80, for use in composing an output message.

If the asset received in Step 76 required a sub-asset to be substituted, then in Step 82 an appropriate sub-asset is substituted.

A further check is then made, in Step 84, to determine whether any further sub-asset substitutions are required. If yes then Steps 82 and 84 are repeated until the asset is complete.

Once complete, the completed asset is stored in Step 80 and, in Step 86, a check is made to see whether any further assets are present in the asset set. If there are further assets (“yes”), then the process returns to Step 76. If there are no further assets (“no”), then the composer operates to compose a composed asset set (Step 88).

In a simple messaging system, all variations of composed assets that can be created from the asset set received from the library search system are created and added to the composed asset set. In a variation, asset assignments may be prioritized based on their relevance metric and only a limited number of composed assets may be produced.

For each composed asset, a relevance for the composed asset is created by combining the relevance metric of all the user sub-assets below it, for example by taking the inverse of the sum of the inverse of each used asset's relevance metric such that

R_{composed}=1−(π(1−R_{composed}))

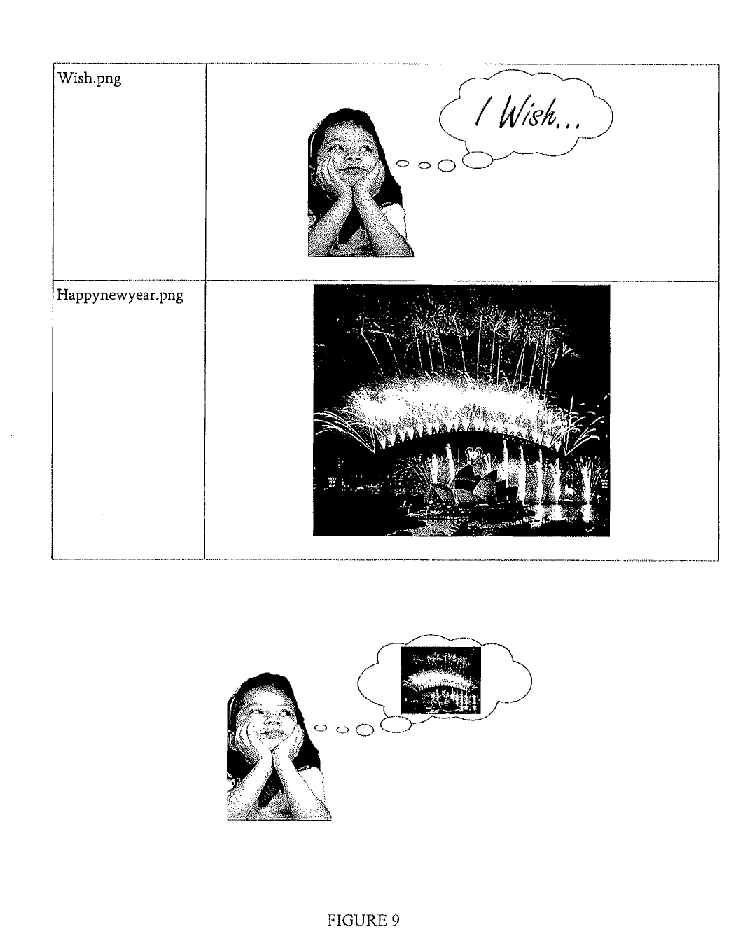

FIG. 8 shows three different composed asset set representations based on the asset set (and combined relevance values) of FIG. 6.

The first representation in the top row of FIG. 8 may be taken to indicate that a composed asset, comprising of “wish.png” as the primary asset with “happynewyear.png” taking the place of the sub-asset identified as “#a-wish” has a composed asset relevance of 100%. It is noted that this composed asset relevance value is calculated as

R_{composed}=1−((1−0.95)×(1−1.00)=1−((0.05)(0))=1

The last representation in the bottom row of FIG. 8 may be taken to indicate that a composed asset, comprising of “wish.png” as the primary asset with “fatherxmas.png” taking the place of the sub-asset identified as “#a-wish” has a composed asset relevance of 96.75%. It is noted that this composed asset relevance value is calculated as

R_{composed}=1−((1−0.95)×(1−0.35)=1−((0.05)(0.65))=0.9675=96.75%

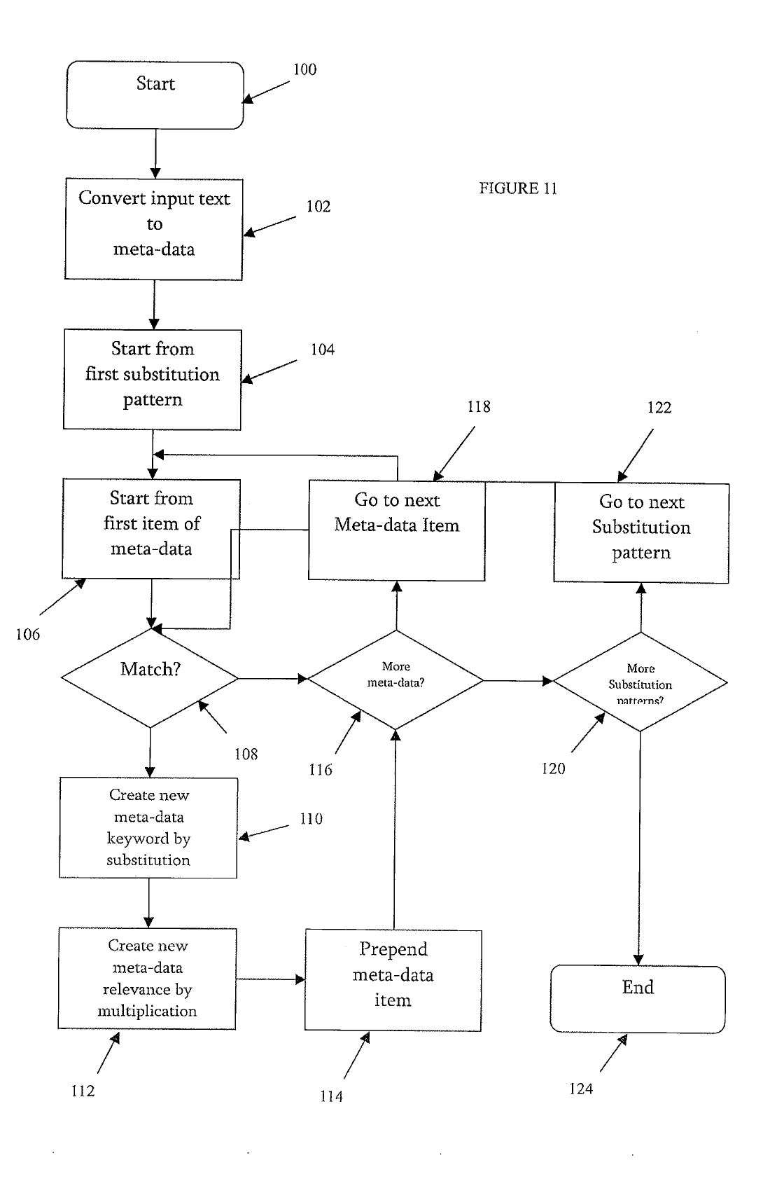

FIG. 9 shows an example of the assets and composed asset result for the top row entry of FIG. 8. In this example, the “wish.png” asset is an image of a young girl with a thought bubble containing the words “I wish . . . ”. It is noted that the “I wish . . . ” content of the thought bubble is a placeholder for a further asset.

The “happynewyear.png” asset in FIG. 9 is an image of the New Year's Eve celebrations at the Sydney harbour bridge.

The composed asset is the “wish.png” asset with the bridge image substituted into the thought bubble.

As discussed above in relation to FIG. 2, the text-to-meta-data converter 5 takes the input text 3 and returns a set of meta-data. In one embodiment of the present invention a set of substitution patterns may be used to from the full output set of meta-data.

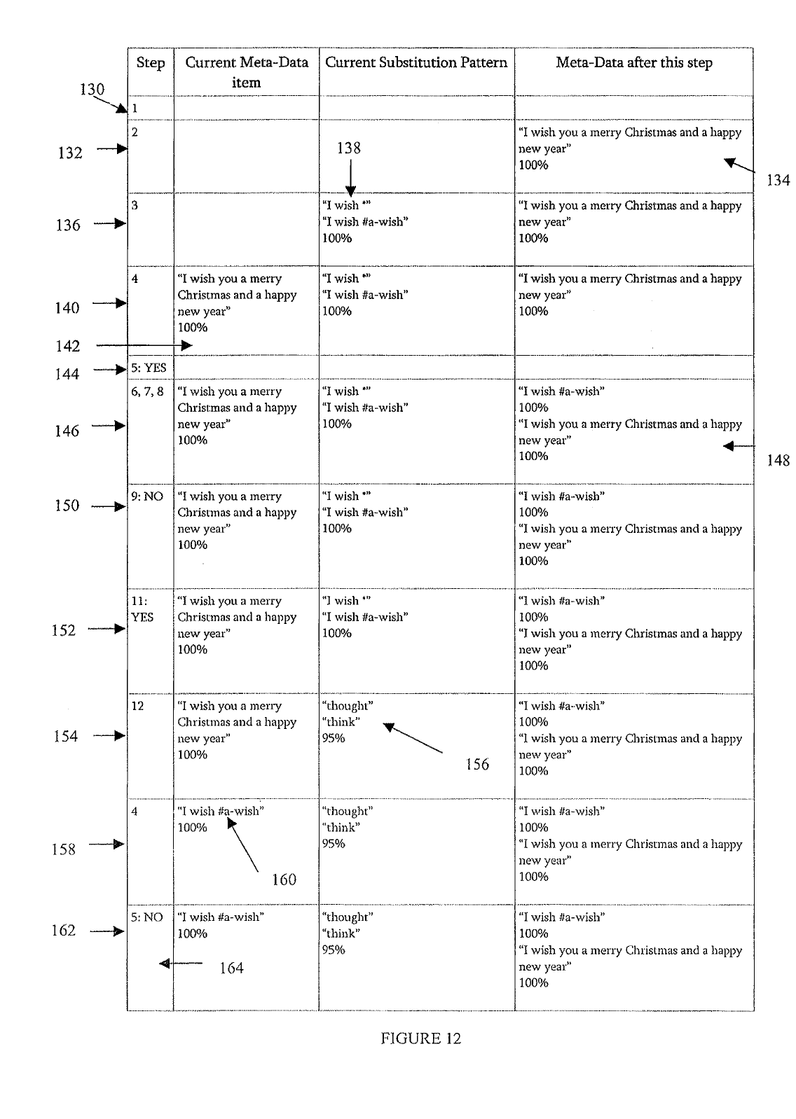

FIGS. 10, 11 and 12 illustrate one example of how a substitution pattern approach may be used to generate a set of meta-data.

Consider FIG. 10 in which each substitution pattern has three elements: (i) the input matching sequence of characters; (ii) the substituted sequence of characters; and (iii) the relevance multiplier.

The substitution pattern in the second row of FIG. 10 (labeled 90) may be interpreted as “wherever the sequence of characters ‘I wish’ followed by any number of any other characters appear, you can substitute the sequence ‘#a-wish’ for the characters that follow ‘I wish’, and the relevance metric should be multiplied by 100% to give the resulting metric for the result of the substitution”.

The second pattern (row 92 in FIG. 10) corresponds to “wherever the sequence of characters ‘thought’ appear, the sequence of characters ‘think’ may be substituted and the relevance metric should be multiplied by 95%”.

The last pattern (row 94) corresponds to “wherever the sequence of characters ‘Monday’ appear, the sequence of characters ‘weekday’ may be substituted and the relevance metric should be multiplied by 50%”.

A number of character pattern matching and substitutions are well know, for example regular expression, as defined in the IEEE POSIX Basic Regular Expressions standard.

In such a substitution pattern approach, an input string is first converted into an item of meta-data by associating it's exact sequence with a suitable relevance metric, for example 100%. So, an input string “I wish you a merry Christmas and a happy new year” becomes the meta-data item

TABLE A

| | |
|---|---|
| “I wish you a merry Christmas and a happy new year” | 100% |

Further items of meta-data may be created and added to the meta-data set by iteratively applying each of the substitution patterns to all existing meta-data items and multiplying the relevance metric until there are no further patterns to be applied to any further meta-data items.

For the example substitution patterns given in FIG. 10, the resulting meta-data set would be:

TABLE B

| | |
|---|---|
| “I wish you a Merry Christmas a happy | 100% |
| new year” | |
| “I wish #a-wish” | 100% |

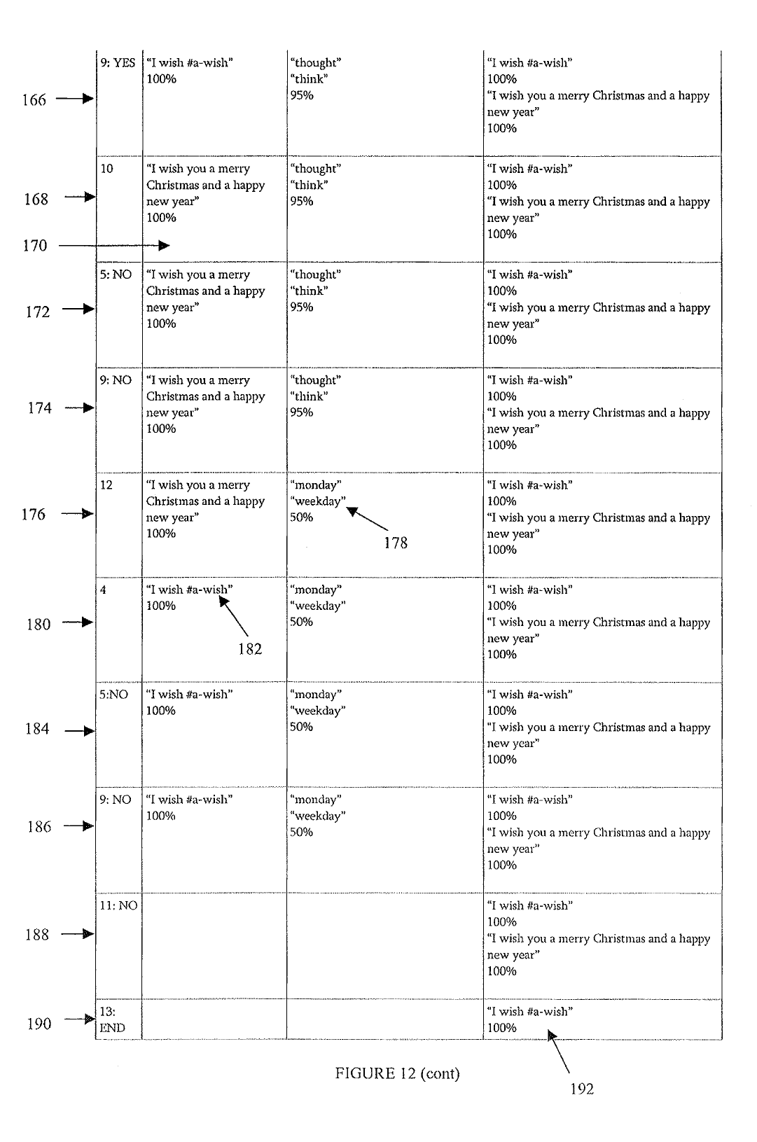

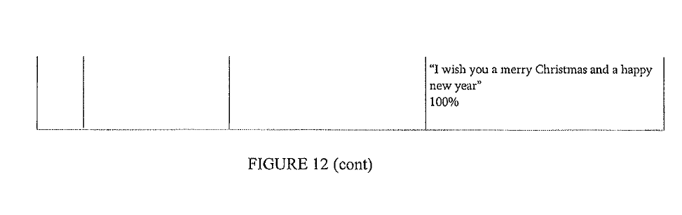

The process followed to generate the above meta-data set is shown in FIGS. 11 and 12 and is described below.

FIG. 11 shows a flow chart depicting the logic steps followed in generating the meta-data set. FIG. 12 is a corresponding table showing the various meta-data items and substitution patterns under consideration at any given point in the process.

The process begins in Step 100 of FIG. 11 (Row 130 of the table of FIG. 12).

At Step 102 (row 132, FIG. 12), the converter receives the input text which is to be converted into meta-data. An exact copy of this input text is inserted in box 134 of the table of FIG. 12.

In Step 104 (row 136, FIG. 12), the first substitution pattern from FIG. 10 is selected. This pattern appears in box 138 in FIG. 12.

In Step 106 (row 140, FIG. 12), the first item of meta data is selected. For the first cycle of the process this first item of meta-data is the exact sequence of input text (see also box 142 in FIG. 12).

In Step 108 (row 144, FIG. 12), the converter determines if there is a match between meta-data item in box 142 and the pattern in box 138. In this instance there is a match based on the substitution rules described above and the answer at Step 108 is recorded as “Yes”.

In Steps 110, 112 and 114 (row 146, FIG. 12), a new meta-data item is added to the meta-data items held by the converter. This is illustrated by box 148 which now shows the “I wish #a-wish” meta-data item is present. It is noted that the relevance of 100% is determined by multiplying the relevance value of the first substitution pattern with that of the second pattern. As can be seen in FIG. 10 this is 100% by 100%.

It is further noted that the new meta-data item is added to the beginning of the list of meta-data items held by the converter.

In Step 116 (row 150, FIG. 12), the converter checks to see if there is any more meta-data in its current list of meta-data items that has not been checked against the first substitution pattern. If any further meta-data items are present then the converter moves to Step 118 and retrieves the next meta-data item and then cycles through steps 108-114 again.

However, as indicated in row 150 of the table in FIG. 12, in the present example there are no further meta-data items that need to be checked against the first substitution pattern.

The converter therefore moves to Step 120 (row 152, FIG. 12) in which it checks if there are further substitution patterns to consider. As can be seen in FIG. 10, there are three patterns in total and so the answer to Step 120 is “Yes”.

In Step 122 (row 154, FIG. 12), the next substitution pattern is selected (see also box 156 in FIG. 12) and the converter cycles back round to Step 106 (row 158, FIG. 12) in which the converter selects the first item of meta-data held in its list of meta-data items—see box 160 in FIG. 12.

In Step 108 (row 162, FIG. 12) the converter determines if there is a match between the current meta-data item and the current substitution pattern. In the present example there is no match and the converter returns the answer “No”—see box 164) before moving onto Step 116 (row 166, FIG. 12).

In Step 116, the converter checks its list of current meta-data items to see if there are any further items of meta-data to consider against the second substitution pattern. The answer in this case is “Yes” and therefore, in Step 118 (row 168, FIG. 12), the next data item is selected (see box 170 in FIG. 12).

The converter then moves onto Step 108 again (row 172, FIG. 12) and determines whether there is a match between the meta-data item and the substitution pattern. In the present example there is no match and so the converter moves to Step 116 (row 174, FIG. 12) and determines if there are any further meta-data items to consider. In the present example there are no further meta-data items and so the converter moves to Step 120 (row 176, FIG. 12) and checks if there are any more substitution patterns to consider in FIG. 10.

In the present example there is one further substitution pattern to consider and this pattern is selected in Step 122 (see box 178 of row 176 in the table of FIG. 12). At Step 106 (row 180, FIG. 12), the first item of meta data is selected (box 182 in FIG. 11) and in Step 108 (row 184, FIG. 12) the converter determines if there is a match.

There is no match in the present case and so the converter moves to Step 116 (row 186, FIG. 12) to determine if there are any further meta-data items to consider. In the present case there is a further meta-data item—“I wish you a merry Christmas”. The process of rows 176 to 186 in FIG. 12 is therefore repeated for this meta-data item, i.e. it is selected in Step 118 and considered for a match in Step 108. Again there is no match in the present case and so the converter returns to Step 116. Note: this meta-data item is not illustrated in FIG. 12 but follows the process as detailed in rows 176 to 186.

There are now no further meta-data items to consider and so the converter moves to Step 120 (row 188, FIG. 12). There are now no further substitution patterns to consider and so the converter ends the meta-data transformation process at Step 124 (row 190, FIG. 12).

It can be seen that the output of the substitution pattern process of FIGS. 10 to 12 is in box 192 of row 190, FIG. 12 and that this corresponds to table B above.

It will be understood that the embodiments described above are given by way of example only and are not intended to limit the invention. It will also be understood that the embodiments described may be used individually or in combination.

It is noted, for example, that the system according to the present invention may output visual assets for the whole or only part of, an input text string. The system may also output the original text based message in conjunction with the visual asset output.

1. A system for enabling enhancement of a text-based message with visual assets, the system comprising:
input means for receiving message text;
a data store comprising a plurality of visual assets;
search means arranged to compare data related to the message text received at the input means against data related to the plurality of visual assets stored in the data store in order to identify at least one visual asset that corresponds to a portion of the message text;
composing means arranged to receive the at least one visual asset identified by the search means and to compose at least one composed asset set in dependence upon the at least one visual asset identified by the search means and the message text received at the input means;
output means arranged to output the at least one composed asset set.

2. A system as claimed in claim 1, wherein each visual asset stored in the data store is associated with at least one piece of meta-data and the system further comprises a meta-data converter arranged to convert message text received at the input means into a set of input meta-data.

3. (canceled)

4. A system as claimed in claim 2, wherein the data store comprises a second plurality of substitution patterns, the meta-data converter being arranged to utilize the substitution patterns to convert the message text into the set of input meta-data.

5. A system as claimed in claim 2, wherein the search means is arranged to compare the meta-data related to the plurality of visual assets with the set of input meta-data and, wherein each of the at least one piece of meta-data is associated with an asset relevance indicator, the indicator being arranged to indicate the relevance of the meta-data to its associated visual asset.

6. (canceled)

7. A system as claimed in claim 5, wherein the meta-data converter is further arranged to generate an input relevance indicator, the indicator being arranged to indicate the relevance of the input meta-data to the message text.

8. A system as claimed in claim 7, wherein the search means is arranged to determine a combined relevance indicator for each visual asset in the data store based on the combination of the input relevance indicator and the asset relevance indicator.

9. A system as claimed in claim 8, wherein the combined relevance indicator is determined by multiplying the asset relevance indicator with the input relevance indicator.

10. A system as claimed in claim 1, wherein the search means is arranged to add visual assets that are identified as corresponding to message text to an asset set.

11. A system as claimed in claim 9, wherein the search means is arranged to add visual assets that are identified as corresponding to message text to an asset set and wherein the search means is arranged to add visual assets to the asset set in dependence upon their combined relevance indicator.

12. A system as claimed in claim 11, wherein the search means is arranged to limit the size of the asset set in dependence upon combined relevance indicator values.

13. A system as claimed in claim 1, wherein the composing means is arranged to combine two or more visual assets together to form the at least one composed asset set and wherein the composing means is arranged to determine all possible combinations of visual assets identified by the search means and to compose a plurality of composed asset sets.

14. (canceled)

15. A system as claimed in claim 13, wherein for each combination of visual assets the composing means is arranged to determine a composed relevance indicator indicating the relevance of the combination of visual assets to the message text received at the inputs.

16. A system as claimed in claim 13, wherein the composing means is arranged to limit its composition to a predetermined number of composed asset sets.

17. A system as claimed in any claim 1, wherein the output means is arranged to output the at least one composed asset set for display on a display device.

18. A system as claimed in any claim 1, wherein the output means is arranged to output the at least one composed asset set: in the form of an email communication; or in the form of an instant message; or to a wireless communications device.

19. (canceled)

20. A system as claimed in claim 18, wherein the output means is arranged to output the message text as received at the input means in addition to the at least one composed asset set.

21. A system as claimed in any claim 1, wherein the plurality of visual assets stored in the data store comprise some or all of the following asset types: bitmap images, vector images, video clips, animations.

22. A communication system comprising a system according to claim 1.

23-26. (canceled)

27. A communication system according to claim 22 wherein the communication system comprises one or more of: an email communication system; an instant messaging system; and a system for sending and receiving messages at a wireless communications device.

28. A data carrier comprising a computer program arranged to configure a computer to enhance a text based message with visual assets, wherein the computer program comprises:
a code segment for receiving message text;
a code segment for searching a data store comprising a plurality of visual assets and comparing data related to the message text against data related to the plurality of visual assets in order to identify at least one visual asset that corresponds to a portion of the message text;
a code segment for composing at least one composed asset set in dependence upon the at least one visual asset and the message text; and
a code segment for outputting the at least one composed asset set.
